(19) United States
(12) Patent Application Publication
(10) Pub. No.: US 2005/0140040 A1
(43) Pub. Date: Jun. 30, 2005

(54) Resin molded product of luminous colorant formed using special mold and luminous colorant composition

(76) Inventor: Shingo Hishida, Suita (JP)

Correspondence Address: LORUSSO, LOUD & KELLY, 3137 Mount Vernon Avenue, Alexandria, VA, 22305, US

(21) Appl. No.: 11/000,508

(22) Filed: Dec. 1, 2004

(30) Foreign Application Priority Data
Dec. 25, 2003 (JP) 2003-429983

(51) Int. Cl. B29C 41/22

(52) U.S. Cl. 264/73; 428/30

(57) ABSTRACT

It is an object to provide a resin molded product of a luminous colorant, free of weld lines. The product is obtained by molding a mixture of a luminous coloring agent and a resin by the use of a mold engraved with a pattern having a plane face on an internal surface.

### FIELD OF THE INVENTION

The present invention relates to a method for producing a resin molded product of a luminous colorant, a resin molded product of a luminous colorant, and a luminous coloring agent composition.

### BACKGROUND OF THE INVENTION

A conventional molded product of a thermoplastic resin incorporated with a coloring agent of luminous colorant involves a problem of black lines, referred to as weld lines, notably generated during a molding process, in particular an injection molding. Therefore, the molded product is coated or plated to mask these lines. The resulting increase in production cost is one of the major disadvantages involved in the conventional method.

The related industry has been investigating various methods to deal with the weld lines. Some of the methods proposed so far include a variation of grain size of a luminous colorant incorporated, a treatment of a luminous colorant with a dispersant and a devising the mold gate position. However, they have failed to produce the satisfactory results.

JP-A-7-41599 discloses a molded article prepared by molding a resin composition comprising 100 parts of a thermoplastic resin and 0.1 to 10 parts of a pearly pigment having the largest outer diameter of 10 to 200 μm, all parts by volume.

JP-A-7-118561 discloses a coloring agent for plastics, comprising glossy metallic particles having the largest outer diameter of 10 μm to 1.5 mm, coated with a metallic soap.

JP-A-8-239505 discloses a resin composition comprising 100 parts of a thermoplastic resin, 0.01 to 15 parts of a weld eraser having a refractive index of 1.8 or more, a coloring agent and a luminous material, all parts by weight.

JP-A-2003-73557 discloses a resin composition comprising 100 parts of a resin and 0.01 to 10 parts of graphite, all parts by weight.

### SUMMARY OF THE INVENTION

In the conventional technique, a weld line appears as a black line at a point at which a molten resin injected into a mold via a pouring gate joins together in whorls after flowing in the lateral direction.

These weld lines have been particularly noted when metallic foil particles or pearly color flaky particles are incorporated in a conventional technique. The flaky colorant is used for a luminous colorant.

The inventors of the present invention have found that a generation of the weld lines in an article molded by a conventional technique can be suppressed by securing turbulences of a molten resin in a mold to prevent unidirectional flow.

The present inventors have confirmed that a mold engraved with a pattern having a plane face on an internal surface (i.e., at a portion coming into contact with a molten resin) brings a significant effect of suppressing a generation of the weld lines.

However, it is essential for a surface of the engraved pattern to have a plane face, because the object of the present invention is to produce a luminous molded product incorporated with a luminous colorant.

The present invention also incorporates fine inorganic particles in a luminous colorant at a given content. This produced a satisfactory result of suppressing generation of the weld lines almost completely.

The present invention have solved problems and drawbacks involved in the conventional techniques, described above. It is an object of the present invention to provide a novel method for forming a resin molded product of a luminous colorant. It is another object to provide a resin molded product of luminous colorant. It is still another object to provide a luminous coloring agent composition.

The present invention provides a method for producing a resin molded product of a luminous colorant comprising the steps of:

mixing a luminous coloring agent and a resin to form a mixture:

melting and injecting, under pressure, the mixture into a mold engraved with a pattern having a plane face on an internal surface to mold the mixture to obtain a molded product.

The present invention also provides a resin molded product of a luminous colorant, which is obtained by:

mixing a coloring agent composition of a luminous coloring agent and inorganic fine particles with a resin to form a mixture;

melting and injecting, under pressure, the mixture into a mold engraved with a pattern having a plane face on an internal surface to mold the mixture to obtain a molded product.

The present invention also provides a resin molded product of a luminous colorant, which is obtained by:

mixing a luminous coloring agent and a resin to form a mixture;

melting and injecting, under pressure, the mixture into a mold engraved with a pattern having a plane face on an internal surface to mold the mixture to obtain a molded product.

The present invention also provides a luminous coloring agent composition for forming a resin molded product of a luminous colorant, wherein the composition comprises inorganic fine particles and a luminous coloring agent, and the inorganic fine particles are incorporated at 0.01 parts by weight or more per 100 parts by weight of the resin.

Other objects, features and advantages of the invention will become apparent from the following description of the embodiments of the invention taken in conjunction with the accompanying drawings.

### BRIEF DESCRIPTION OF THE DRAWINGS

FIGS. 1(A) and (B) show surface conditions of molded products obtained by the present invention.

FIGS. 1(C) and (D) show surface conditions of molded articles with a wale streak pattern (C) and shark skin pattern (D), each having no plane face.

FIG. 1(E) shows a conventional normal molded article with no surface pattern.

### DETAILED DESCRIPTION OF THE INVENTION

So long as the mold for the present invention is a mold engraved with a pattern having a plane face on an internal surface, mold type and pattern type are not limited.

The resin for the present invention is also not limited. For example, a thermoplastic resin is useful for the present invention. Particularly useful for the present invention are known thermoplastic resins, e.g., polyethylene (PE), polypropylene (PP), high-impact polystyrene (PS-HI), acrylonitrile/butadiene/styrene copolymer (ABS), polycarbonate (PC), polyethylene terephthalate (PET), polyamide (PA) and polymethylmethacrylate (PMMA).

The luminous colorant (coloring agent or pigment) for the present invention is not limited. It may be, for example, a pearly colorant comprising mica as a major ingredient (e.g. having an average particle diameter of 10 to 100 μm), and a metal power such as aluminum, copper and brass (e.g. having an average particle diameter of 10 to 100 μm such as 200 meshes (74 μm) or less) and a mixture thereof.

Amount of the luminous colorant used is not limited. It varies depending on a type of the luminous colorant. For example, some colorants are incorporated at 0.01 to 10 parts by weight per 100 parts by weight of the resin. Others can sufficiently exhibit their functions when incorporated at 0.05 parts by weight or less. Some types of the colorants can be incorporated at 0.1 to 5 parts by weight, or 0.2 to 1 part by weight. Colored pellets of a resin kneaded with the colorant may be used. A master batch containing the colorant at a high content may be also used.

The fine inorganic particles for the present invention are not limited. They may be one component selected from the group consisting of calcium carbonate, silica, zeolite, magnesium carbonate, alumina white, aluminum oxide, aluminum silicate, titanium oxide, zinc flower, bentonite and kaolin, or a composite of these components.

Average particle size of the fine inorganic particles is not limited. It may be e.g. 300 meshes (50 μm) or less, preferably several μm or less.

Amount of the fine inorganic particles used is not limited, so long as it is 0.01 parts by weight or more per 100 parts by weight of the resin. For example, it may be 0.1 to 30 parts by weight. The present inventors found that the preferable amount range varies depending on a kind of the resin in which they are to be incorporated. It may be a relatively low level such as 0.01 to 1 part by weight, when the resin has a relatively high melt viscosity, e.g., PS-HI or ABS. Some resin molded product may be free of these fine inorganic particles depending on a shape of the molded product. It may be a relatively high level such as 0.5 to 100 parts by weight, when the resin has a relatively low melt viscosity and is close to liquid, e.g., PP or PE.

The coloring agent composition of the present invention may be incorporated with a known pigment or additive, e.g., dispersant. It is needless to say that each component, i.e., the luminous colorant and the fine inorganic particles (which may be composed of a single component or a composite), may be surface-treated beforehand with the known pigment or additive, e.g., a fatty acid or a salt thereof, wax, amide, silicone, a surfactant or a coupling agent. Moreover, it may be incorporated with a complementary pigment or a property modifier, because it has an effect on the object of the present invention to a limited extent.

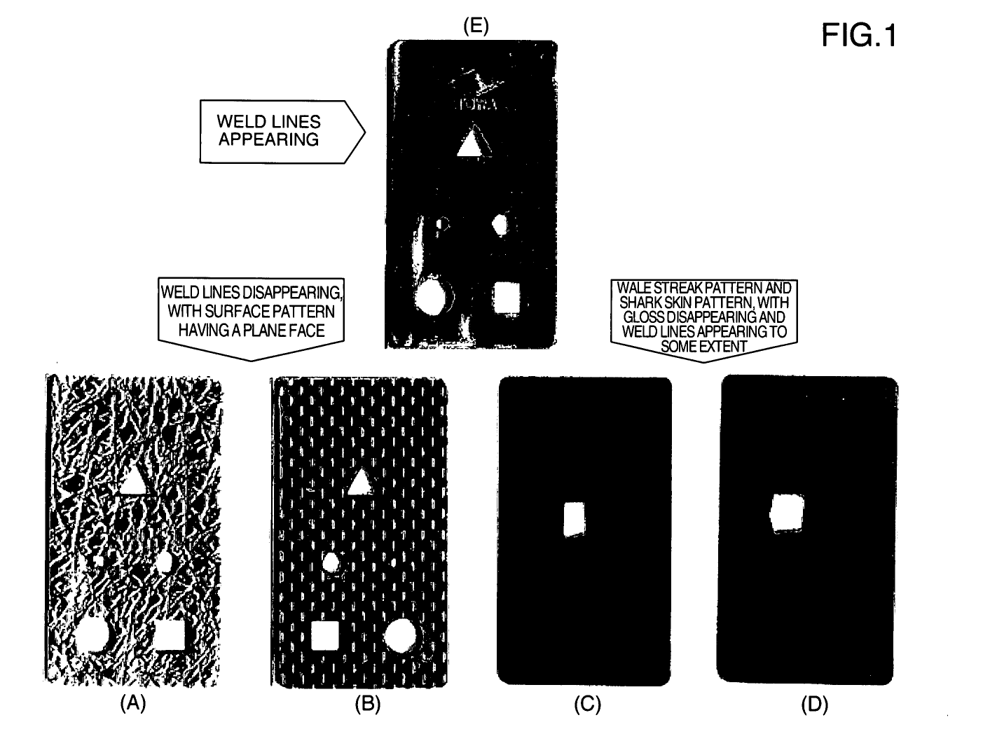

The method of the present invention produces a resin molded product of a luminous colorant by use of a mold which is engraved with a pattern having a plane face on an internal surface (i.e. at a portion coming into contact with a molten resin) in such a way that the molded product obtained has a pattern having a planar view shown in FIG. 1(A) or (B). The mold is not limited, so long as it is engraved with a pattern having a plane face on an internal surface (i.e. at a portion coming into contact with a molten resin).

A mold engraved with a vertical line (wale streak), shark skin or herring bone pattern gives a molded product having no luminosity or no gloss but showing vertical weld lines to some extent, which are difficult to remove completely. See FIG. 1(C) for a shark skin pattern, and FIG. 1(D) for a wale streak pattern.

### EXAMPLES

The present invention is described by Examples.

### Example 1

High-impact polystyrene (PS-HI) was used as a thermoplastic resin. It was incorporated with a varying mixture (coloring agent composition) to prepare resin compositions given in Table 1, where each composition is based on 100 parts by weight of the thermoplastic resin. Each resin composition was injection-molded to prepare a molded product (test article), by the use of a mold which is engraved in such a way to give the molded product having a surface pattern and through-holes shown in FIG. 1(A) or (B). The resulting test articles were visually observed whether or not weld lines were generated. The results are also given in Table 1.

TABLE 1

| | | Molded product | | | | Molded product | |
|---|---|---|---|---|---|---|---|
| | | Pattern- | Pattern- | | | Pattern- | Pattern- |
| Mixture composition | | engraved | engraved | Mixture composition | | engraved | engraved |
| (Unit: Parts by weight) | | mold A | mold B | (Unit: Parts by weight) | | mold A | mold B |
| Mixture 1 (containing only | | ◯ | ◯ | Mixture 2 (containing only | | ◯ | Δ |
| a luminous colorant): | | | | a luminous colorant): | | | |
| Pearly colorant | 0.2 | | | Aluminum powder 900 | 0.2 | | |
| (Treated with dispersant | | | | | | | |
| 0.02) | | | | | | | |
| Mixture 3: | | ⊚ | ⊚ | Mixture 4: | | ⊚ | ⊚ |
| Pearly colorant | 0.2 | | | Aluminum Powder 900 | 0.2 | | |
| Calcium carbonate | 0.5 | | | Calcium carbonate | 0.5 | | |
| Dispersant | 0.1 | | | Titanium oxide | 0.1 | | |
| | | | | Dispersant | 0.1 | | |
| Mixture 5: | | ⊚ | ⊚ | Mixture 6: | | ⊚ | ⊚ |
| Pearly colorant | 0.5 | | | Pearly colorant | 0.2 | | |
| Aluminum powder 900 | 0.2 | | | Oil black B | 0.1 | | |
| Calcium carbonate | 0.5 | | | Calcium carbonate | 0.5 | | |
| Aluminum oxide | 0.2 | | | Dispersant | 0.1 | | |
| Dispersant | 0.1 | | | | | | |

Generation of weld lines:
   Δ: Generated to some extent
   ∘: Generated very slightly
   ⊚: Not generated
Dispersant: Mixture of 4 parts of zinc stearate and 6 parts of magnesium stearate, all parts by weight
Pearly colorant (pearly pigment): Iriogin 120 Luster from Merk (Particle diameter: About 5 to 25 μm)
Aluminum powder 900: Daiwa Kinzoku Ltd., 900M, #900 (Particle diameter: About 15 μm)
Oil black B: Arimoto Chemical Ltd., Oil dye black 5905
Calcium carbonate: Dowa Calfine Ltd., KS-1000
Titanium oxide: Du Pont Ltd., R-101
PS-HI resin: Asahi Kasei Ltd., PS-HI

### Example 2

Polypropylene (PP) resin was used as a thermoplastic resin. It was incorporated with a varying mixture (coloring agent composition) to prepare resin compositions given in Table 2, where each composition is based on 100 parts by weight of the thermoplastic resin. Each resin composition was formed into a molded product in the same manner as in Example 1. The results are also given in Table 2.

TABLE 2

| | | Molded product | | | | Molded product | |
|---|---|---|---|---|---|---|---|
| | | Pattern- | Pattern- | | | Pattern- | Pattern- |
| Mixture composition | | engraved | engraved | Mixture composition | | engraved | engraved |
| (Unit: Parts by weight) | | mold A | mold B | (Unit: Parts by weight) | | mold A | mold B |
| Mixture 7 (containing only | | X | X | Mixture 8 (containing only | | X | X |
| a luminous colorant): | | | | a luminous colorant): | | | |
| Pearly colorant | 0.2 | | | Aluminum powder 900 | 0.2 | | |
| (Treated with dispersant | | | | | | | |
| 0.03) | | | | | | | |
| Mixture 9: | | Δ | Δ | Mixture 10: | | ◯ | ◯ |
| Pearly colorant | 0.2 | | | Aluminum Powder 900 | 0.2 | | |
| Calcium carbonate | 1 | | | Calcium carbonate | 1 | | |
| Dispersant | 0.1 | | | Titanium oxide | 2 | | |
| | | | | Dispersant | 0.5 | | |
| Mixture 11: | | ◯ | ◯ | Mixture 12: | | ⊚ | ⊚ |
| Pearly colorant | 0.2 | | | Aluminum Powder 900 | 0.2 | | |
| Calcium carbonate | 3 | | | Calcium carbonate | 1 | | |
| Silica | 3 | | | Titanium oxide | 2 | | |
| Dispersant | 0.5 | | | Silica | 1 | | |
| | | | | Dispersant | 0.5 | | |

Generation of weld lines:
   X: Generated
   Δ: Generated to some extent
   ∘: Generated very slightly
   ⊚: Not generated
PP resin: Idemitsu Ltd., PP, J-2000G

### INDUSTRIAL APPLICABILITY

The luminous coloring agent composition and the method for producing a resin molded product of a luminous colorant of the present invention can produce a molded product free of weld lines.

### ADVANTAGES OF THE INVENTION

In the present invention, by using a mold, which can form through-holes in a thickness direction, a resin molded product having the through-holes can be produced. The molded product obtained shows no weld line and has a luminous color, in spite of its through-holes.

It should be further understood by those skilled in the art that although the foregoing description has been made on embodiments of the invention, the invention is not limited thereto and various changes and modifications may be made without departing from the spirit of the invention and the scope of the appended claims.

1. A method for producing a resin molded product of a luminous colorant comprising the steps of:
mixing a luminous coloring agent and a resin to form a mixture:
melting and injecting, under pressure, the mixture into a mold engraved with a pattern having a plane face on an internal surface to mold the mixture to obtain a molded product.

2. A method for producing a resin molded product of a luminous colorant comprising the steps of:
mixing a coloring agent composition of a luminous coloring agent and inorganic fine particles with a resin to form a mixture;
melting and injecting, under pressure, the mixture into a mold engraved with a pattern having a plane face on an internal surface to mold the mixture to obtain a molded product.

3. The method according to claim 2, wherein the inorganic fine particles are incorporated at 0.01 parts by weight or more per 100 parts by weight of the resin.

4. A resin molded product of a luminous colorant, which is obtained by:
mixing a luminous coloring agent and a resin to form a mixture;
melting and injecting, under pressure, the mixture into a mold engraved with a pattern having a plane face on an internal surface to mold the mixture to obtain a molded product.

5. A resin molded product of a luminous colorant, which is obtained by:
mixing a coloring agent composition of a luminous coloring agent and inorganic fine particles with a resin to form a mixture;
melting and injecting, under pressure, the mixture into a mold engraved with a pattern having a plane face on an internal surface to mold the mixture to obtain a molded product.

6. A luminous coloring agent composition for forming a resin molded product of a luminous colorant, wherein the composition comprises inorganic fine particles and a luminous coloring agent, and the inorganic fine particles are incorporated at 0.01 parts by weight or more per 100 parts by weight of the resin.
